(19) United States
(12) Patent Application Publication
(10) Pub. No.: US 2010/0078482 A1
(43) Pub. Date: Apr. 1, 2010

(54) Dynamic Barcode System

(75) Inventor: Glenn Patton Bradford, Huntsville, AL (US)

Correspondence Address: DEPARTMENT OF THE ARMY;LEGAL OFFICE, AMSAM - L - G - I, U.S. ARMY AVIATION & MISSILE COMMAND, REDSTONE ARSENAL, AL, 35898-5000, US

(73) Assignee: United States of America as Represented by the Secretary of the Army, Washington, DC (US)

(21) Appl. No.: 12/238,994

(22) Filed: Sep. 26, 2008

(51) Int. Cl. G06K 7/10

(52) U.S. Cl. 235/462.42; 235/462.01; 235/440; 235/462.1; 235/462.46

(57) ABSTRACT

A dynamic barcode system includes a microprocessor connected to a sensor or group of sensors. The microprocessor connects to a barcode display. Data collected by the sensor or group of sensors is processed by the microprocessor and sent to the barcode display. A barcode reader reads the barcode display. The barcode display, microprocessor and group of sensors are arranged on a packet which is attachable to a specimen to be monitored. The barcode reader has an infrared transmitter for sending a signal to an infrared receiver associated with the barcode display. The infrared receiver upon receiving a signal from the barcode reader sends a signal to the microprocessor requesting that the microprocessor send requested data for viewing on the barcode display. The displayed barcode is then read by the barcode reader. In such a manner, continually changing data collected by the sensors can be stored and retrieved as desired.

### DEDICATORY CLAUSE

The invention described herein may be manufactured, used and licensed by or for the U.S. Government for governmental purposes without payment of any royalties to the inventor or to any subsequent assignees.

### BACKGROUND OF THE INVENTION

I. Field of the Invention

The present invention pertains to barcode displays and scanners.

More particularly the present invention pertains to a barcode display and reader which can be used to transfer dynamic information.

II. Discussion of the Background

Barcodes present a well-developed way of allowing a user to retrieve data on some item. This data can be very simple, like a UPC code, or it can be more complex, like the routing information on a package. New barcodes, such as the various two-dimensional barcodes, allow for a relatively dense storage of readable data. In some cases, this can be the equivalent of several thousand bits per square inch.

The technology for generating and reading barcodes is well-developed. Almost every office has both printers for generating barcodes and small hand-held devices for reading barcodes even over a distance. Barcodes and their associated technology are ubiquitous.

Barcodes in all their forms have been used to relate static information. This static information can pertain to any number of parameters including the identification, tracking and routing of items, packages, parcels, containers, etc. By their nature, printed barcodes cannot be used to transfer data that is subject to change. The transfer of dynamic information has typically been done through wired links such as a standard link between a computer and a peripheral, or by wireless communication where the link is provided by radio waves.

Depending on the situation, the traditional links which provide dynamic information may be infeasible to use for one reason or another. These reasons include safety concerns, power requirements, regulatory concerns, and location constraints which preclude the use of such traditional links.

### SUMMARY OF THE INVENTION

Accordingly, one object of the present invention is to provide a barcode data transfer system which can operate on low power when transferring dynamic information.

Yet another object of the present invention is to provide a system in which dynamic barcode information can be retrieved in virtually any setting or location.

These and other valuable objects are realized by a dynamic barcode system having a microprocessor to which a signal generator and a display are connected. The microprocessor processes data from the signal generator and converts the data to barcode signals which signals are received by the display which generates barcodes on a display screen. A barcode reader is used to scan and read the barcodes displayed by the display. The signal generator can be a sensor or set of sensors for imparting information to the microprocessor for readout from the display by the barcode reader.

By connecting a plurality of sensors to the microprocessor, the present invention allows for the monitoring of various statistical parameters (e.g., temperature, humidity, barometric pressure, chemical particles present, time, etc.). Thus, the barcode readings on the display will change as the parameters detected by the sensors change. The display, microprocessor, and sensors have low power source or voltage requirements and the barcode reader is battery operated. The sensors, microprocessor and display can be positioned on a module which is attachable to a specimen for monitoring.

In one embodiment of the present invention, the barcode reader has an associated transmitter for purposes of transmitting an infrared (IR) signal or equivalent signal to a receiver associated with the microprocessor and display. The receiver then sends a signal to the microprocessor to retrieve desired information to be sent to the display for readout by the barcode reader. The microprocessor has memory and processing circuitry for storing and processing information detected by the sensor. The IR link between the barcode reader and display/processor unit allows for a two-way transfer of data or commands to be used for the transfer of dynamic information.

### DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a schematic illustration of a dynamic barcode system according of to the present invention.

FIG. 2 is a schematic illustration of a dynamic bar code system according to an embodiment of the present invention which includes a pixel-addressable display.

FIG. 3 is a schematic illustration according to an embodiment of the present invention which includes a barcode reader having an associated IR transmitter and a barcode display having an associated IR receiver.

FIG. 4 is a block diagram illustrating the sending and receiving of signals of the elements depicted in FIG. 3.

FIG. 5 is a schematic illustration of a display module according to the present invention.

FIG. 6 is a perspective illustration showing display modules of the type shown in FIG. 5 attached to respective specimens.

In the drawings, like reference numerals designate identical or corresponding parts throughout the several views.

### DETAILED DESCRIPTION

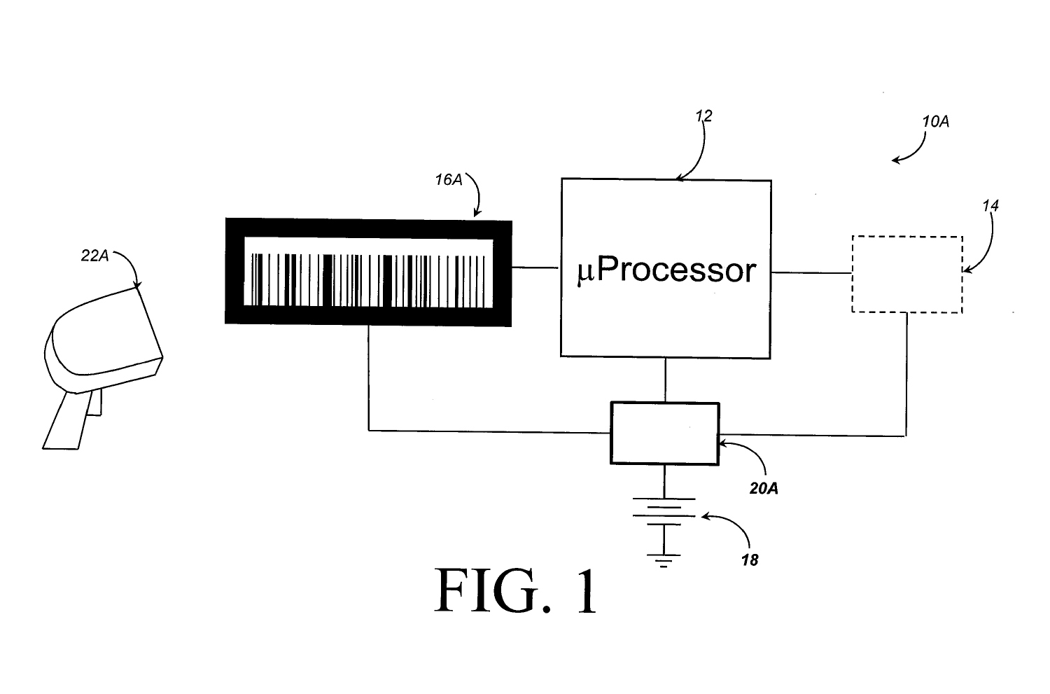

With reference to FIG. 1, a dynamic barcode system 10A according to the present invention includes a microprocessor 12 connected to a signal generator 14 which could, for example, be a notional set of sensors (e.g., sensors which measure temperature, humidity, wind speed, shock, chemical emissions, time in transit, barometric pressure, etc.). Microprocessor 12, signal generator 14, and display 16A receive power from battery 18 through power conditioning circuitry 20A.

The microprocessor 12 logs data from the signal generator 14 and drives a display 16A, e.g., a liquid crystal display (LCD) or equivalent display. A microprocessor appropriate for this application is the Texas Instrument MSP430 microprocessor family or equivalent. From the data collected from the signal generator 14, the microprocessor generates barcodes which are transmitted to the display 16A. A barcode reader 22A is used to read the display. Barcode reader 22A is a battery-powered barcode reader of a type well known to those in the art. The LCD barcode display in U.S. Pat. No. 6,082,620 to Bone, Jr. is an example of a type of LCD display which can be utilized in the present invention.

The barcode display 16A of FIG. 1 is a type that displays only fixed width bars. The various bar widths as required by UPC coding are generated by activating or deactivating consecutive fixed width bars. If more data is needed than can be displayed at one time on fixed-width display 16A, “pages” of information are displayed in a series of barcodes representing sequential data.

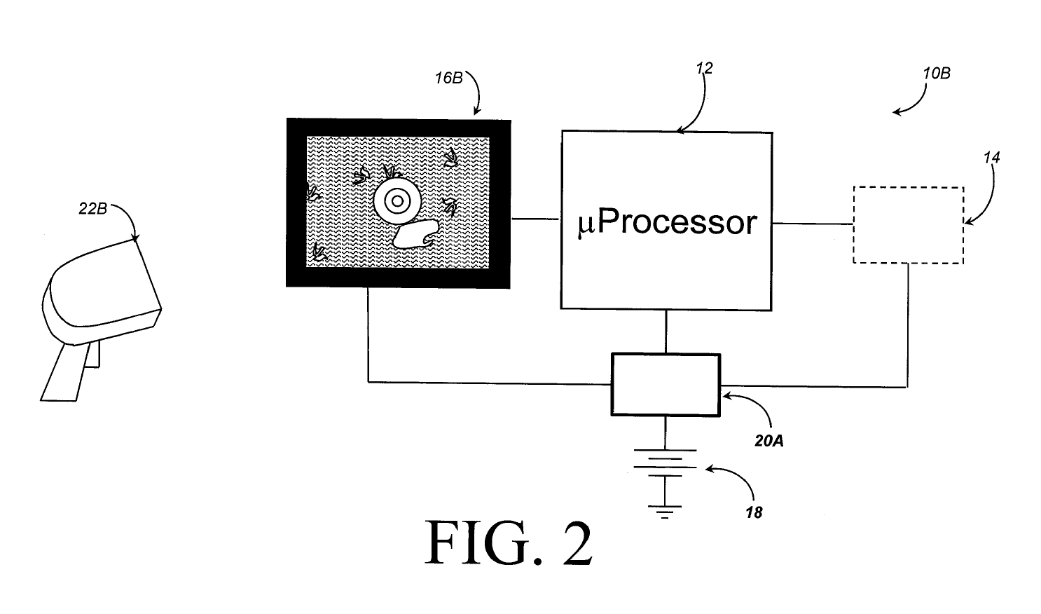

With reference to FIG. 2, system 10B has a pixel addressable matrix display 16B which is connected to microprocessor 12 (e.g., the display 16B is a pixel addressable LCD display or a bistable cholesteric display or equivalent). Microprocessor 12 is connected to signal generator 14. In that display 16B is pixel addressable this allows for the display of two-dimensional barcodes such as Maxi Code, Aztec Code and the like which are read by 2-D capable barcode reader 22B. The Kent Displays 240×680×2.9 SPI display is an example of a bistable cholesteric display (BCD) device which is capable of presenting such a two-dimensional barcode for utilization in the present invention. The use of a large display matrix allows more information to be read in one scan.

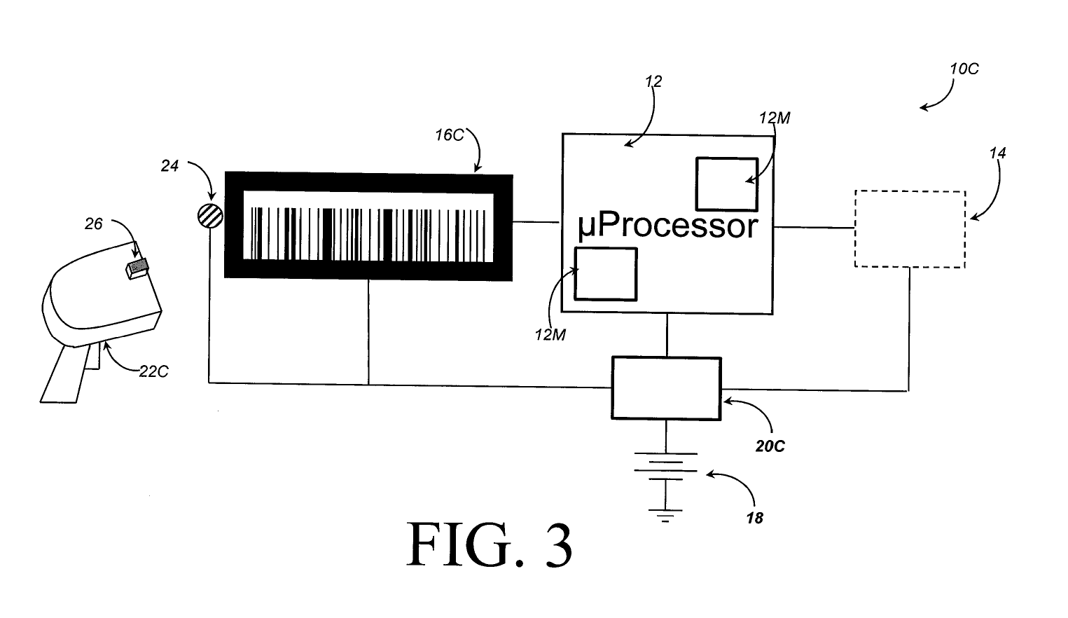

In FIG. 3, system 10C has a display 16C which is an LCD display or equivalent display. Display 16C is a fixed width or pixel addressable display or other appropriate display. Display 16C is provided with an IR receiver 24, an example of which is the Sharp Electronics GP1U52X IR module or similar device. Microprocessor 12 (e.g., a Texas Instruments MSP430F2xA microcontroller or other appropriate microprocessor) connects to signal generator 14 and to display 16C. The microprocessor 12 allows data detected by signal generator 14 to be displayed on display 16C or allows data stored in the microprocessor 12 to be modified by the data detected by signal generator 14 and then displayed on display 16C.

The system is designed to operate with very low power requirements, with the battery 18 or power source requirements being less than 1.5 volts. Power regulation circuitry 20C in conjunction with battery 18 (FIG. 3) accommodate the power requirements of the IR receiver 24, display 16C, microprocessor 12 and signal generator 14. For example, with the battery 18 operating at 1.3 volts nominally, a peak current draw on the order of 32.7 milli-amperes occurs when driving the display 16C. Battery 18 can be a small lithium thionyl chloride coin cell, such as the Tadiran TL-4986 which should last for 2½ years (a larger coin cell, such as the Tadiran TL-4935, would power the system for up to ten years). In a reasonable operational schedule where the display 16C would be updated once a day for 20 seconds, with the system being in a low-power mode otherwise, an average consumption would be on the order of 475 micro-ampere-hours per day.

In the embodiment of FIG. 3, the IR receiver 24 receives a signal from the transmitter 26 associated with barcode reader 22C. The transmitter 26 is a simple IR light emitting diode (LED). Transmitter 26 is integrated with barcode reader 22C, receives power from barcode reader 22C, and is controlled by the power regulation circuitry and control electronics (not shown) of barcode reader 22C. The signal from transmitter 26 causes IR receiver 24 to send a signal to microprocessor 12 telling microprocessor 12 to send data for displaying on display 16C. Microprocessor 12 then sends the data to display 16C. As an example, the signal from transmitter 26 could represent a command requesting the receiving system to return stored data. The receiver 24 would then forward the command to the microprocessor 12 to retrieve the desired information for display in barcode form on display 16C for readout by the barcode reader. The transfer of commands or data by an IR link can follow the methodology of the Infrared Data Association (IrDa) protocol or other appropriate protocol.

The microprocessor 12 (FIG. 3) has memory 12M and processing circuitry 12P for storing and processing information detected by the sensor. The IR link between the barcode reader and display/processor unit allows for a two-way transfer of data or commands to be used for the transfer of dynamic information.

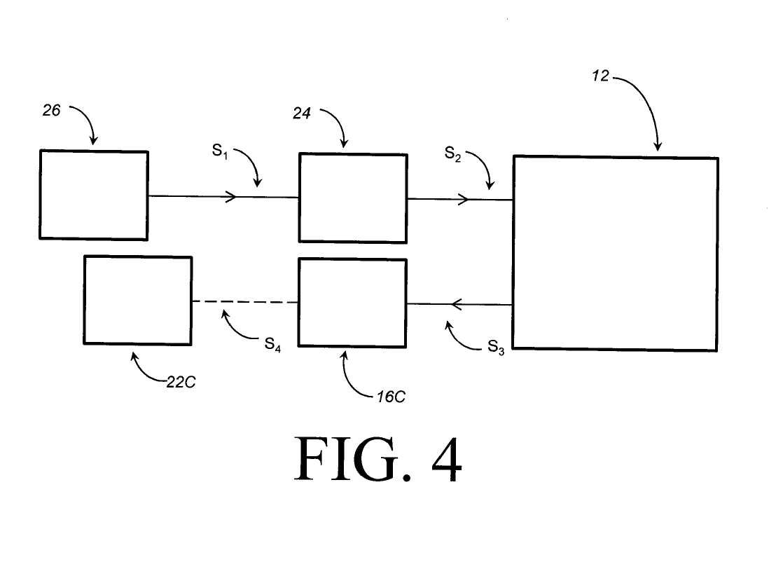

A block diagram of the signaling just described is provided in FIG. 4. IR transmitter 26, such as an Infrared Data Association (IrDA) type infrared transmitter, sends a signal S₁ to IR receiver 24. IR receiver 20 then sends a signal S₂ to microprocessor 12. Microprocessor 12 then sends a signal S₃ to display 16C. Display 16C then displays a barcode corresponding to the signal S₃ which is read by barcode reader 22C. Dotted line 30 represents the line of sight between reader 22C and display 16C.

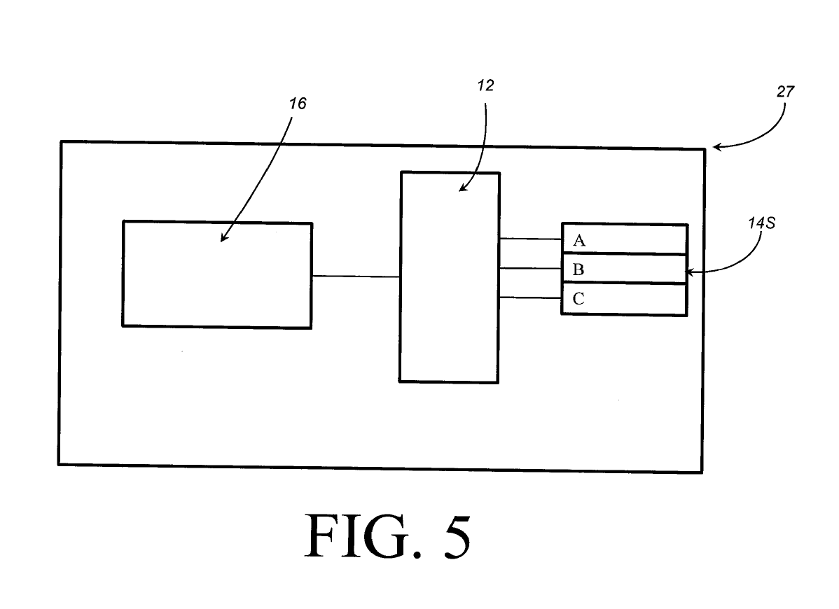

FIG. 5 is a schematic of a display module 27 according another embodiment of the present invention. The display module 27 includes a microprocessor 12 connected to a barcode display 16 and a sensor 14S. The sensor 14S is in actuality a packet of sensors with a sensor A being one type of sensor, a sensor B being another type of sensor and a sensor C being yet another type of sensor. The display module has a light weight plastic base to which the microprocessor 12, barcode display 16 and sensor 14S are mounted so as to be easily attachable to a given specimen.

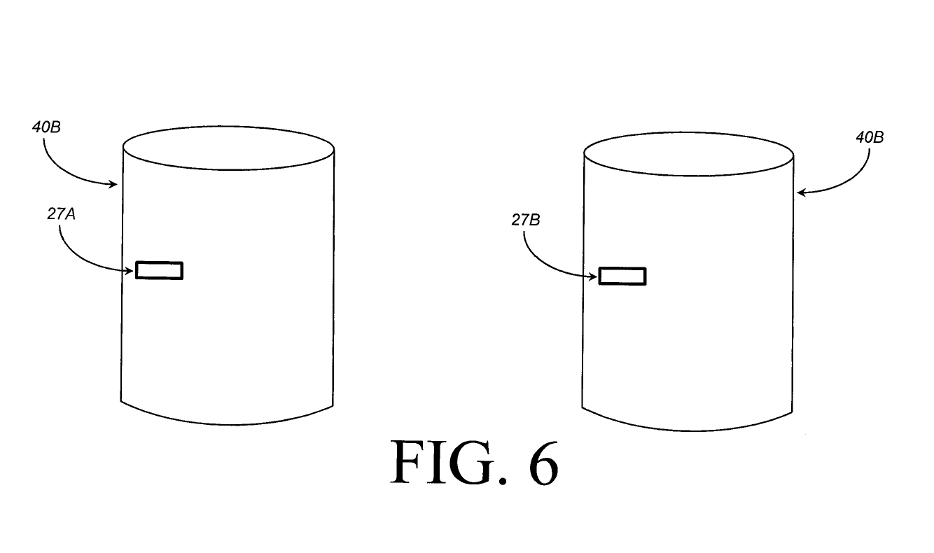

In FIG. 6 a display module 27A and display module 27B according to the present invention are attached to respective specimens 40A and 40B. The specimens 40A and 40B are exemplary of numerous types of items to which a display module 27 may be attached. For example the specimens 40A and 40B may be barrels containing a certain chemical which requires continual monitoring.

The display modules 27A and 27B would be equipped with sensors 14S (see, FIG.5) to provide data concerning the barrels such as the temperature to which the barrels have been exposed, the duration of exposure, chemical leaks detected, etc.

The present invention allows information to be retrieved and read from specimens located in remote locations and locations not readily amenable to RF signals. (RF signals are often unable to penetrate a specimen′ surroundings; and, certain types of specimens are unsafe to use in an RF environment.)

The system of the present invention can be used to track inventory and to continually update the location and probable condition of the inventory as it is moved from place to place and from different temperature and weather conditions.

Further, in that the present invention can be fabricated from relatively low cost, existing technical components, the economics of the system are most attractive both in initial cost and the efficiency and cost savings provided.

Various modifications are possible without deviating from the spirit of the present invention. Accordingly the scope of the invention is limited only by the claim language which follows hereafter.

What is claimed is:

1. A dynamic barcode system, comprising:
a barcode display;
a microprocessor connected to said barcode display;
a signal generator connected to said microprocessor for supplying the microprocessor with data which are converted by the microprocessor to barcode signals for displaying barcodes on said barcode display.

2. A dynamic barcode system according to claim 1, wherein:
said signal generator comprises at least one sensor.

3. A dynamic barcode system according to claim 2, wherein:
said signal generator comprises a plurality of sensors.

4. A dynamic barcode system according to claim 3, wherein:
said barcode display, said microprocessor and said signal generator are arranged on a module, said module being attachable to a specimen.

5. A dynamic barcode system, according to claim 4, further comprising:
a barcode reader.

6. A dynamic barcode system, comprising:
a barcode reader connected to an infrared transmitter;
a barcode display connected to an infrared receiver for receiving a transmission from said infrared transmitter;
a microprocessor connected to said barcode display;
a signal generator connected to said microprocessor.

7. A dynamic barcode system according to claim 6, wherein:
said barcode display is a fixed width barcode display.

8. A dynamic barcode system according to claim 6, wherein:
said barcode display is a pixel addressable matrix LCD display.

9. A dynamic barcode system according to claim 6, wherein:
said barcode display is a bistable cholesteric display.

10. A dynamic barcode system according to claim 6, wherein:
said barcode reader is a 2-D capable barcode reader.

11. A dynamic barcode system according to claim 6, wherein said signal generator comprises at least one sensor.

12. A dynamic barcode system according to claim 11, wherein:
said barcode display, said microprocessor and said at least one sensor are arranged on a module, said module being attachable to a specimen.

13. A dynamic barcode system according to claim 6, wherein:
said barcode display, said microprocessor and said signal generator are arranged on a module, said module being attachable to a specimen.

14. A dynamic barcode system according to claim 6, wherein:
said infrared transmitter sends a first signal to said infrared receiver and said infrared receiver sends a second signal to said microprocessor and said microprocessor sends a third signal to said display.

15. A dynamic barcode system according to claim 14, wherein:
said barcode reader reads said barcode display after said third signal is sent to said barcode display.

16. A dynamic barcode system according to claim 13, wherein:
said signal generator comprises a plurality of sensors.

17. A dynamic barcode system according to claim 10, wherein:
said microprocessor includes memory for data storage.

18. A dynamic barcode system according to claim 11, wherein:
said barcode display, said microprocessor and said signal generator are connected to a power source of less than 1.5 volts.

19. A dynamic barcode system according to claim 16, wherein:
said plurality of sensors are arranged on a sensor packet on said module.
